(19) United States
(12) Patent Application Publication
(10) Pub. No.: US 2024/0068783 A1
(43) Pub. Date: Feb. 29, 2024

(54) METHOD FOR DETERMINING POSITION OF A LASER POINT APPLIED IN A FIREARM TRAINING SIMULATION SYSTEM USING INFRARED LASERS

(71) Applicant: VIETTEL GROUP, Ha Noi City (VN)

(72) Inventors: Anh Tuan Vu, Ha Noi City (VN); Duc Thanh Nguyen, Ha Noi City (VN); Van Duc Ha, Thanh Hoa City (VN); Kim Duc Hoang, Cam Lo District (VN); Thanh Nhon Nguyen, Ha Noi City (VN); Anh Tra Duong, Ha Noi City (VN); Tran Nam Nguyen, Hanoi City (VN)

(73) Assignee: VIETTEL GROUP, Ha Noi City (VN)

(21) Appl. No.: 18/358,234

(22) Filed: Jul. 25, 2023

(30) Foreign Application Priority Data
Aug. 31, 2022 (VN) 1-2022-05576

(51) Int. Cl. F41G 3/26; G06V 20/40; G06V 20/80

(52) U.S. Cl. CPC F41G 3/2655; G06V 20/44; G06V 20/80; G06V 2201/07

(57) ABSTRACT

A method to detect, identify and determine the position of laser points from infrared laser emitters in a firearm training simulation system. The method consists of two steps. This first step combines some common tools such as a camera with a filter switcher and edge and corner detecting algorithms in image processing to provide a fast automatic screen calibrating method. The second step is to detect laser point objects in each frame continuously captured by the camera, and then further process these objects to identify laser shots, filter out noisy objects, and eventually detect simulated shots from different laser emitters and determine the final mapped position of the shot.

### FIELD OF THE INVENTION

This invention is related to weapon simulators, in particular the laser emitter and method to detect laser shots by a camera within a firearm training simulation system.

### BACKGROUND OF THE INVENTION

In a firearm training simulation system, it is common to use an infrared laser transmitter mounted on a simulated gun or a real gun to generate laser shots. To further reduce interference, laser emitters are generally used with a specific wavelength, typically 850 nm. The receiver could be a target attached with infrared sensors to receive the laser signal directly, or a system of camera, projector and screen to capture the reflected laser signal. Within a system that uses camera to detect laser shots onto virtual targets, the camera must be equipped with a corresponding narrow band pass filter for the chosen wavelength. This camera system requires a screen calibration step, or more precise, a screen mapping step, in which either the camera detects the alignment, corners and edges of the screen automatically, or these specifications have to be set manually. In either case, the infrared filter is often manually removed so that the camera can capture the screen with visible light, and then reattached after the mapping process is done, or if sometimes the filter is fixed and not to be detached, there must be a marking technique with extra infrared illuminations. This can be a tedious process if it has to be done regularly, for example if the system is required to be mobile, or if there are ground vibrations that affects the system configuration, due to nearby construction for example.

Furthermore, the laser transmitter is required to shoot a laser beam right after the hammer hits the firing pin when the user pulls the trigger, so that there is the smallest delay possible. In some system, a wired electro-mechanical trigger mechanism is placed at the gun trigger, or at the hammer, or at the edge of the slider. This is an almost fool proof method but the wiring can be tricky and affects gun handling. In some other systems, a shock sensor is used to detect the firing moment. This type of sensor eliminates the wiring problem but it is sensitive to noise. For example, the gun slider can cause other vibrations within one shot if the gun is equipped with a recoil simulator.

Another issue is that there can be multiple weapons shooting at the same time onto the screen, thus there must also be a method to distinguish between each shot. To solve this detection and synchronization problem, wireless connection such as WIFI, Bluetooth or RF are common choices, but again there are wiring and gun handling issues when assembling onto a real gun, because the laser emitting device needs more space for the antenna to work properly.

### SUMMARY

The present invention provides a method to solve the aforementioned problems for a system in which a camera is used to capture the laser shot from a real gun equipped with a laser emitter and a recoil kit. This method has mainly 2 steps: screen mapping and laser shot detection. The first step includes the combination of a camera, attached with a filter switcher, and image processing to quickly and automatically handle the screen mapping process. In the second step, there is a technique to detect and distinguish laser shots without using any common wireless data communication technology. This technique utilizes the characteristics of shock signals, and the properties of the image of the reflected laser beam to identify laser shots.

### BRIEF DESCRIPTION OF THE DRAWING

FIG. 1 is a diagram of an exemplary embodiment of the firearm training simulation system that applies this present invention.

FIG. 2 is a flow chart of the method of detecting laser shots and simulated shots.

FIG. 3 is a sample table of laser objects in consecutive frames.

FIG. 4 is a sample magnitude-time graph of shock signals received on the shock sensor of the laser emitter

### SPECIFIC DESCRIPTION

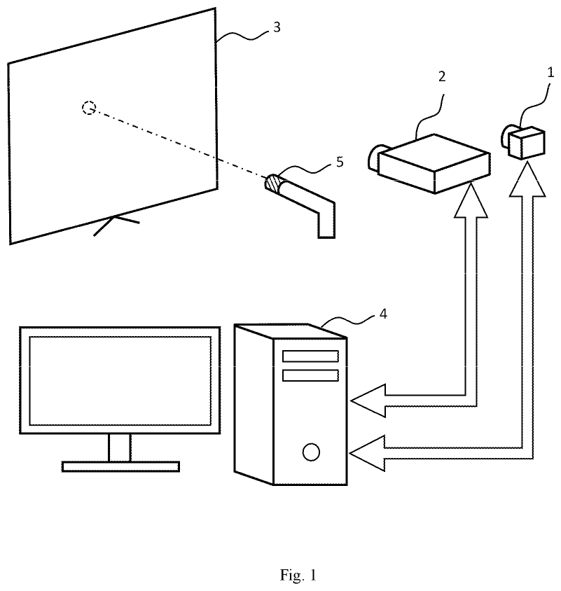

The firearm training simulation system that applies the method in this present invention consists of a laser emitter and recoil kit mounted on a real firearm, a camera with an infrared filter switcher, a projector, a workstation and a reflective screen as shown in FIG. 1.

The high-speed camera 1 captures infrared images of the screen and its surrounding area with no less than 120 fps at default resolution. The camera is equipped with an infrared wavelength filter that matches the wavelength of the laser transmitter, typically 850 nm. This type of camera features a switch between the aforementioned infrared filter and a regular visible light filter, which can be software-controlled from the workstation. The camera can continuously stream both compressed and uncompressed image data. The infrared image data obtained from the camera is a single layer matrix with the maximum numbers of rows and columns corresponding to the resolution of the camera.

The projector 2 connected to the workstation projects high resolution images onto the screen 3. The screen 3 is used to show the virtual targets for training, and also to ensure a certain reflected intensity of laser shots. The camera 1 and projector 2 are directly connected to the workstation 4. The workstation 4 receives and processes data from the camera with a laser detection software, and also render images of virtual targets from the main application for the projector.

Infrared laser emitter 5, has a wavelength corresponding to the infrared filter on the camera, which can be reprogrammed to change the time period for a single laser shot or spread it into a certain pattern, e.g. emits for 5 ms then stops for 5 ms then emits again for 10 ms. The laser device mounted at the front of a gun emits a laser beam in a certain time period, or in a patterned time period, whenever it receives a shock signal large enough right after the trigger is pulled and the hammer hits the firing pin. The gun can be equipped with a recoil kit, either hydraulic or electromagnetic, to simulate recoil force, and because of this recoil simulator the slider can also create shocks that can activate the laser emitter. Based on the analysis of different shock signal types, which depend on the gun and recoil kit mechanisms, each laser emitter is then programmed to beam with a small difference from another. The laser emitter only receives signal from shocks, and in returns only send out laser beams, without any other form of data communication with the workstation or other devices within this system.

Details of the design and manufacture of any of these devices, including the workstation, the camera, the laser emitter, the gun or the recoil kit are not within the scope of this invention. In other words, the present invention works with any of kind of cameras or laser emitters that have these aforementioned specifics.

Several similar technical terms used within this present invention related to the firearm and the laser emitter will be clarified below:

A simulated shot is a process starting from when the user pulls the trigger, then the hammer on the gun hits the firing pin, then the slider on the gun moves back towards the shooter by means of a recoil simulator, and then the slider moves back to the original position, and the process ends when the entire gun returns to the original state as it was before pulling the trigger. Each simulated shot is supposed to simulate a real gunshot, and the system will have to distinguish each of these simulated shots to correctly generate a virtual shot towards virtual targets.

A laser shot is a short time period, normally no longer than 100 ms, in which the laser continuously beams onto the screen. The laser shot is activated whenever the shock sensor from within the laser emitter receives high magnitude vibrations as shock signals. A simulated shot should normally comprises of several laser shots, either due to multiple shock signals during the whole simulated shot, or because the laser emitter is programmed to send multiple laser shots in a pattern instead of one single beam over time. The shortest shot, whether in a pattern or not, must span at least 2 frames based on the capture frequency of the camera.

A laser object, a laser point, a laser point object, or simply an object, is a set of neighboring pixels with the intensity above a certain threshold on an image in a single frame captured by the camera. This object is detected by image processing within each frame. In each laser shot, as defined above, the camera can capture several consecutive frames, and each one of these frames contains at least one laser object corresponding to the laser shot.

Provided herein are embodiments of the present invention. The method includes an automatic screen alignment calibration step, also called screen mapping step, and laser shots detection step. Although these steps are shown as a sequential process, these steps also work like different modes of operations. Step 1 always need to complete at least once before Step 2 is operational.

The first main step, the screen mapping, follow the substeps below. This step combines some common tools such as a camera with a filter switcher and edge and corner detecting algorithms in image processing to provide a fast automatic screen mapping method that takes seconds.

Substep 1a: Turn on the system, including the camera, workstation and projector and start the mapping process. The camera is automatically set to enter visible band mode, or infrared filter off mode.

Substep 1b: The workstation renders a few monotone calibration images and projects them onto the screen. The images can be some or all of the following: horizontal black white stripes, vertical black white stripes, checkered board pattern, or random pattern with corner markers. The camera is programmed to capture each image once and the software on the workstation saves these snapshot separately.

Substep 1c: The images are put through some standard image processing algorithms to determine the corners, edges and the bounded area in the camera captured frame in which the screen spans. In case of failure, mostly due to high intensity ambient light, the software will automatically attempt to start again from substep 1b while adjusting brightness and contrast of the captured images. After a few attempts, if the program still fails to finish detect all required information, the images are exported and then an error will be generated. If the process succeeded, moves on to substep 1d.

Substep 1d: Based on the information calculated in substep 1c, and the specifications of the camera and the patterns from the original images, the workstation is able to generate a mapping from any point inside the aforementioned bound area of the screen in the camera image to a corresponding point in the original images. The mapping can be in a form of a transformation matrix or a set of coefficients for second degree functions, depending on the images used and the distortion of the images:

P(x_{original},y_{original})=M×P(x_{camera},y_{camera})

Substep 1e: Save the mapping and the boundary parameters. This ends the screen mapping step.

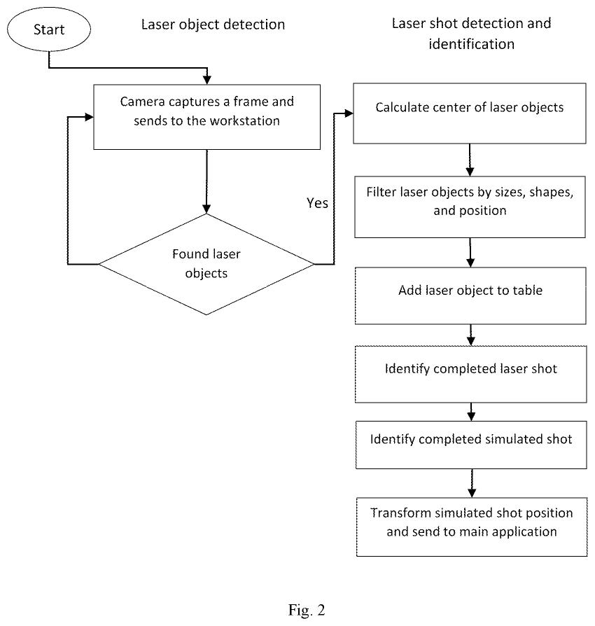

The second step is to detect laser objects in each captured frame, and then further process these objects to identify laser shots, filter out noisy objects, and eventually detect simulated shots from different laser emitters and determine the final position of the shot on the original image. The substeps for this part is explained below, as shown in FIG. 2.

Substep 2a: At the start of this step, the camera switches to infrared filter on mode.

Substep 2b: The camera repeatedly captures and streams real time image data to the workstation.

Substep 2c: Each captured frame is processed to detect group of bright pixels that can be labeled as potential laser objects and filter out image noises by number of pixels in each object. The object detection substeps, including substep 2b and substep 2c, are looping over and over.

From substep 2d until the end, although these are presented as substeps, the workstation only process further in the event when at least one potential laser object is found, and these substeps in fact runs in a separated sequence for laser shot detection and identification, parallel to the loop of substep 2b and substep 2c. Normally the object detection loop and the laser shot detection sequence runs in different threads on the workstation, but if the camera has some image processing functions then some of these substeps, from 2b to 2e can be done solely on the camera instead.

Substep 2d: Calculate the center point of each laser objects in one capture frame, by using a center of mass type equation:

$${P}_{x - camera} = \frac{\sum {V}_{i} \times {x}_{i}}{\sum {V}_{i}} \\ {P}_{y - camera} = \frac{\sum {V}_{i} \times {y}_{i}}{\sum {V}_{i}}$$

Where V is the gray value of a pixel inside a potential laser object. This value, in order to be considered as bright enough, must always be higher than a predetermined threshold.

Substep 2e: Further filter out false laser objects based on their shape, sizes and position. For example, if the center position of an object is out of bounds, which was calculated in the first step above, the object is ignored even if it is actually from a laser shot.

Substep 2f: Add these potential laser objects into a table according to the following rules:

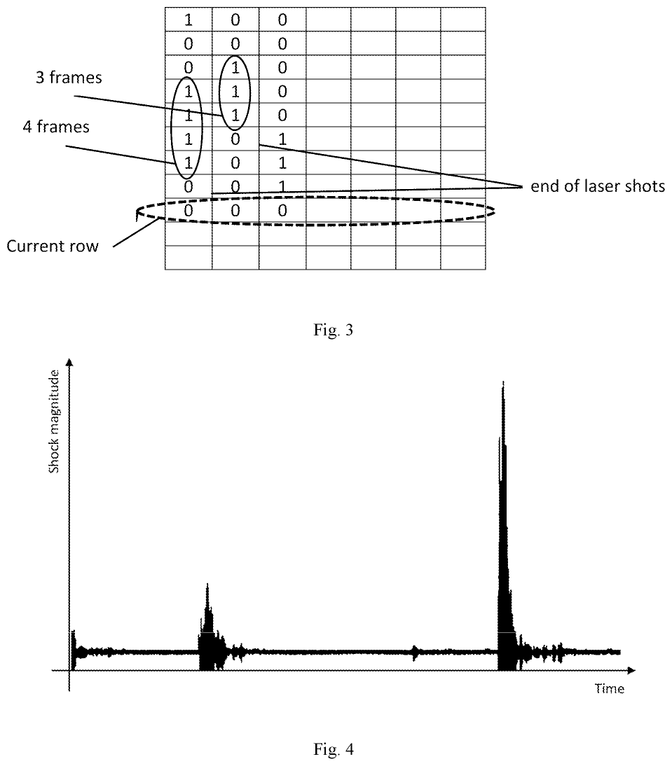

The columns correspond to detected laser shots, each of which can contain multiple laser objects, while the rows correspond to consecutive frames. The number of columns and rows should be large enough to contain all possible laser objects. For example if there are at most 6 firearms firing at the same time, there should be no less than 6 columns, while there must be at least 10 rows if each laser shot lasts about 8 frame long. In each row, add zeros to all column if there is no object in the corresponding frame. FIG. 3 illustrates a sample laser object table.

While processing a new frame, add one to a column with all zeros or a new column if there is an object that is not in close proximity to another object in the previous frame. If the center position of a detected object is in close proximity to another object in the previous frame, add one in the same column with this older object. If there is no object in close proximity to another object in the previous frame, add a zero to the same column under this older object. The appropriate range of the vicinity of each object has to be found by experiments with the laser emitter on each type of firearms.

At the last rows, due to the limit size of the table, simply shift all rows up by deleting the top row and add a new row at the bottom.

Substep 2g: Identify laser shots after each frame according to the following rules:

Each laser shot spans a certain number of frames, for example a 10 ms shot can span 3 to 4 frames at 240 fps. At the start of a new frame, check the previous rows column by column. If there are multiple consecutive ones in one column and there is a zero in that previous row right after the last one in the same column, then this can be a laser shot and the duration of the shot is over as the zero indicates the shot has ended. If the number of consecutive ones, starting from the bottom counting backward, corresponds to a possible number of frames, this is confirmed as a laser shot from a certain laser emitter. If the number of ones is smaller than any possible number of frames, the current column of ones is discarded as a false shot. If the number of ones is larger than any possible number of frames, there can be multiple laser shots in close proximity, but they will be counted as one laser shot only. If the number of ones reach over a certain upper threshold, the laser shot is classified as an endless laser beam instead. In general, endless laser beams should not be used together with laser shots. More detail on the usage of endless laser beams are presented in the next substep.

The position of a laser shot is determined as the center position of the object in the first frame of the series, or in other words the first row that contains a one in this column.

Substep 2h: Identify simulated shots:

As mentioned above, in an actual simulated shots there should normally be multiple laser shots. A sample of the shock signal on a handgun is shown in FIG. 4: the laser emitter in this case will emit three laser shots according to three detected peaks, both have magnitudes higher than a certain threshold. The first peak corresponds to vibrations caused by the hammer hitting the firing pin. The time period between these peaks always fall in a certain range, and the position of the laser shots from the same simulated shot always fall into a certain dispersion region on the captured image. This forms a kind of pattern in both space and time almost unique to each type of firearms, and also unique to each firing mode on the same firearm, such as semi-automatic, burst or full automatic. Hence, simulated shots from different laser emitters can be identified. Any laser shot that do not follow a known pattern can be discarded as noisy response of the laser emitter to shock signals not related to an actual simulated shot. Each pattern can be found experimentally solely with the camera, and the software on the workstation can be configured to detect multiple types of pattern.

In another embodiment, each time a shock signal peak above the threshold, the laser emitter can instead separate one laser shot, which consist of one beam over the whole period, into a pattern of short burst, and so the whole simulated shot becomes double layers patterned.

In another embodiment, the power output of the laser emitter may be configured in order to change the size of the laser object, without any hardware reconfiguration or lens switching. A brighter beam results in a larger laser object, which can be identified in substep 2e. This can combine with the aforementioned pattern or double layers pattern to better identify the shots.

In another embodiment, laser emitters can keep beaming steadily over time, thus while the program is still running a detected laser shot becomes endless. The battery in the laser will be drained much faster, so this embodiment is often used when the laser emitter is wired to an external power source. In this case, the programming for each laser emitter works in reversed: a laser emitter stops beaming for a certain period whenever it receives high magnitude shock signals. This stopping period can also be separated into a pattern. Hence, the method works exactly the same, except that the stopping periods now replace the laser shots. The position of a shot is determined by the position of the laser object in the last frame right before the stopping period starts.

Substep 2i:

The position of the first laser shot in a simulated shot is then registered as the actual position of the simulated shot. This, while still on camera image, can be transformed into the corresponding position on the original image by the mapping found in substep 1d. The final 2D mapped position is then sent to the main application to simulate a virtual shot in 3D environment.

The whole process in step 2 keeps running until the main application, the laser detection software or the camera is stopped.

What is claimed is:

1. A method to detect, identify and determine the position of laser points shot onto a screen from infrared laser emitters, using only a camera and workstation, and without using extra wireless communication technologies, including an automatic screen alignment calibration step, also called screen mapping step, and laser shots detection step; although these steps are shown as a sequential process, they also work like different modes of operations;
the first main step, screen mapping, further decomposed into the substeps below, combines some common tools including a camera with a filter switcher and edge and corner detecting algorithms in image processing to provide a fast automatic screen mapping method:
substep 1a: turn on the system, including the camera, workstation and a projector and start the mapping process, and said camera is automatically set to enter a visible band mode, or also called infrared filter off mode;
substep 1b: the workstation renders a few monotone calibration images and projects them onto the screen, these images can be selected from some or all of the following: horizontal black white stripes, vertical black white stripes, checkered board pattern, or random pattern with corner markers, and said camera is programmed to capture each image once and a laser detection software on the workstation saves these snapshot separately;
substep 1c: the images are put through image processing algorithms to determine the corners, edges and the bounded area in the camera captured frame in which the screen spans, and in case of failure, mostly due to high intensity ambient light, the software automatically attempts to start again from substep 1b while adjusting brightness and contrast of the captured images, and then after a few attempts: if the program still fails to finish detect all required information, the images are exported and then an error is generated, or if the process succeeded, move on to substep 1d;
substep 1d: based on the information calculated in substep 1c, and specifications of the camera and patterns from the original images, the workstation generates a mapping from any point inside the aforementioned bound area of the screen in the camera image to a corresponding point in the original images, and said mapping is in a form of a transformation matrix or a set of coefficients for second degree functions, depending on the images used and the distortion of the images:
P(x_{original}, y_{original})=M×P(x_{camera}, y_{camera});
substep 1e: save the mapping and the boundary parameters, and here ends the screen mapping step;
the second main step is to detect laser objects in each captured frame, and then further process these objects to identify laser shots, filter out noisy objects, and eventually detect simulated shots from different laser emitters and determine the final position of the shot on the original image, and this second step comprises of the following substeps:
substep 2a: at the start of this step, the camera switches to an infrared filter on mode, or simply called infrared mode;
substep 2b: the camera repeatedly captures and streams real time image data to the workstation;
substep 2c: each captured frame is processed to detect group of bright pixels that can be labeled as potential laser objects and filter out image noises by number of pixels in each object, and these object detection substeps, including substep 2b and substep 2c, are looping over and over;
from substep 2d until the end, although these are presented as substeps, the workstation only process further in the event when at least one potential laser object is found, and these substeps run in a separated sequence for laser shot detection and identification, in parallel with the loop of substep 2b and substep 2c;
substep 2d: calculate the center point of each laser objects in one capture frame, by using a center of mass type equation:
$${P}_{x - camera} = \frac{\sum {V}_{i} \times {x}_{i}}{\sum {V}_{i}} \\ {P}_{y - camera} = \frac{\sum {V}_{i} \times {y}_{i}}{\sum {V}_{i}}$$
where V is a gray value of a pixel inside a potential laser object;
substep 2e: further filter out false laser objects based on their shape, sizes and position;
substep 2f: add these potential laser objects into a table having columns and rows according to the following rules:
the columns correspond to detected laser shots, each of which can contain multiple laser objects, while the rows correspond to consecutive frames;
while processing a new frame, add one to a column with all zeros or a new column if there is an object that is not in close proximity to another object in the previous frame, or if a center position of a detected object is in close proximity to another object in the previous frame, add one in the same column with this older object, or if there is no object in close proximity to another object in the previous frame, add a zero to the same column under this older object, and then at the last rows, due to the limit size of the table, simply shift all rows up by deleting the top row and add a new row at the bottom;
substep 2g: identify laser shots after each frame:
each laser shot spans a certain number of frames, and so at the start of a new frame, check the previous rows column by column according to the following rules:
if there are multiple consecutive ones in one column and there is a zero in that previous row right after the last one in the same column, then this can be a laser shot and the duration of the shot is over as the zero indicates the shot has ended, and then if the number of consecutive ones, starting from the bottom counting backward, corresponds to a possible number of frames, this shot is confirmed as a laser shot from a certain laser emitter, or if the number of ones is smaller than any possible number of frames, the current column of ones is discarded as a false shot, or if the number of ones is larger than any possible number of frames, there can be multiple laser shots in close proximity but they will be counted as one laser shot only, or if the number of ones reach over a certain upper threshold, the laser shot is then classified as an endless laser beam instead, and then after the type of the laser shot is identified, the position of said laser shot is then determined as the center position of the object in the first frame of the series, which is the first row that contains a one in this column;
substep 2h: identify simulated shots:
the laser shots form a kind of pattern in both space and time almost unique to each type of firearms, and also unique to each firing mode on the same firearm, such as semi-automatic, burst or full automatic, and each pattern is found experimentally solely with captured images from the camera in advance, and said laser detection software on the workstation is also configured to detect multiple types of pattern in advance, and thus simulated shots from different laser emitters can be identified, and then any laser shot that do not follow a known pattern is discarded as noisy response of the laser emitter to shock signals not belong to an actual simulated shot;
substep 2i:
the position of the first laser shot in a simulated shot is then registered as the actual position of the simulated shot, and said position is transformed into the corresponding position on the original image by the mapping found in substep 1d, and then the final 2D mapped position is sent to a main simulation application to create a virtual shot in 3D environment.

2. The method according to claim 1, wherein, each time a shock signal peak is above the threshold, the laser emitter can instead separate one laser shot, which consist of one beam over the whole period, into a pattern of short burst, and so the whole simulated shot becomes double layers patterned.

3. The method according to claim 1, wherein, the power output of the laser emitter may be configured in order to change the size of the laser object, without any hardware reconfiguration or lens switching, and a brighter beam results in a larger laser object, which can be identified in substep 2e, and thus this can combine with the aforementioned pattern or double layers pattern to better identify the shots.

4. The method according to claim 1, wherein laser emitters can keep beaming steadily over time, often used when the laser emitter is wired to an external power source, and in this case, the programming for each laser emitter works in reversed: a laser emitter stops beaming for a certain period whenever it receives high magnitude shock signals, and said stopping period can also be separated into a pattern; hence, the method works exactly the same, except that the stopping periods now replace the laser shots, and the position of a shot is determined by the position of the laser object in the last frame right before the stopping period starts.
